(19) United States
(12) Patent Application Publication
(10) Pub. No.: US 2010/0144053 A1
(43) Pub. Date: Jun. 10, 2010

(54) MULTIPLEX ASSAY READER SYSTEM

(75) Inventors: Robert C. Haushalter, Los Gatos, CA (US); Shifa Xu, Santa Clara, CA (US)

Correspondence Address: DUANE MORRIS LLP - Princeton, PO BOX 5203, PRINCETON, NJ, 08543-5203, US

(73) Assignee: PARALLEL SYNTHESIS TECHNOLOGIES, Santa Clara, CA (US)

(21) Appl. No.: 12/517,248

(22) PCT Filed: Dec. 4, 2007
(86) PCT No.: PCT/US07/86400

§ 371 Date: Jan. 21, 2010

Related U.S. Application Data
(60) Provisional application No. 60/872,662, filed on Dec. 4, 2006.

(51) Int. Cl. G01N 21/00

(52) U.S. Cl. 436/164; 422/82.05

(57) ABSTRACT

A system for reading optical codes includes a set of beads or particles, each of which has a surface functionalization selected for attaching a biomolecule to be studied, and a device for reading an optical code provided by rare earth-based light emitter associated with each of the beads or particles. The device includes an excitation source and a color CCD light detector. The excitation source excites the rare earth-based light emitters of each of the beads, thereby causing the emitters to emit light having a unique ratio of relative intensities, the unique ratio of the relative intensities forming the optical code of the bead or particle. The color CCD light detector detects the emitted light having the unique ratio of the relative intensities and a memory stores an image of the emitted light.

### RELATED APPLICATIONS

This application claims the benefit of U.S. Provisional Application Ser. No. 60/872,662, filed on Dec. 4, 2006, the entire disclosure of which is incorporated herein by reference.

### FIELD OF THE INVENTION

This invention relates to optically encoded beads for genomic and proteomic investigations and studies. More particularly, the invention relates to multiplex assay optically encoded bead reader and system.

### BACKGROUND OF THE INVENTION

During the last decade there have been many advances in the area of simultaneous on-chip analysis of hundreds or thousands of DNA and protein samples. While chip based assays have continued to grow with many new applications constantly emerging, there are many studies that could benefit from a bead-based or “suspension array” format. In the area of gene expression or genotyping for very large numbers of samples, bottlenecks occur in the process flow during hybridization, particularly during the loading and processing of large numbers of hybridization cassettes. Another drawback to this type of technology is either the substantial cost of purchasing pre-synthesized arrays/scanners or printing arrays in house using microcontact printing.

To address these issues several technologies employ bead-based approaches, or suspension arrays, in order to increase sample density and throughput and to expedite sample handling and reaction kinetics. Because around a billion 10 μm particles occupy about 1 mL volume, there is a potential to achieve very high sample densities, but densities approaching those of traditional slide are chip-based microarrays, have yet to be commercially realized. Current optical encoding schemes, which use organic dyes or quantum dots, have commercially available multiplexing depths of less than 100 samples, which is much smaller than all but the lowest density microarrays.

The fundamental reason for the low multiplexing depth is that the width of the emission peaks from organic dyes or quantum dots is sufficiently broad relative to the width of the silicon detector window, which creates difficulties during deconvolution of the overlapping peaks.

To address this problem, the assignee herein has developed a new class of rare earth-based optical encoding materials. It has been statistically demonstrated that around one billion optical codes may be resolved using these encoding materials. The previous work has also demonstrated that it is possible to robustly attach DNA to beads.

In order to obtain both the spatial location and spectral resolution required to read such a large number of optical codes in a bead foiinat, a rather expensive hyperspectral imaging apparatus is presently required to provide the requisite throughput and resolution. To understand and contrast the choices and possibilities for obtaining the requisite spectral and spatial information on beads, reference is made to the three basic prior art bead reader systems shown in FIGS. 9A-9C. The three systems represent a series of compromises between sensitivity, spatial and spectral resolution, speed and cost. The point scanning system shown in FIG. 9A, is used in several popular scanners and is difficult to surpass in response time and sensitivity. However, spatial resolution is provided only by the size of the focused probe beam and the rather crude spectral information is provided by notch and bandpass filters. At the high end of the cost and throughput gamut is the hyperspectral imaging system, which provides high resolution images with pixel level spectral information. The hyperspectral system generates, with a line-focused laser beam dispersed onto a 2-D Electron Multiplying CCD (EMCCD) via an imaging monochromator, a “hyperspectral data cube”. This cube may be envisioned as a 2-D image with the third dimension of the cube formed by a complete (400-750 nm) emission spectrum for each pixel of the image, thereby providing complete spatial and spectral information. While the hyperspectral imager quickly provides very complete spectral and spatial information, and is mandatory for deconvoluting the very large numbers of optical codes provided by the earlier mentioned new class of rare earth-based optical encoding materials, the system is quite expensive.

Since the hyperspectral system is so costly, and many researchers will not need encoded bead sets capable of labeling millions of samples, there is a need for a less expensive reader system capable of analyzing on the order of hundreds of beads.

### SUMMARY

According to one embodiment, a system for reading optical codes, the system comprising a set of beads or particles, and a device for reading an optical code provided by each of the beads or particles. Each of the beads or particles includes a surface functionalization selected for attaching a biomolecule to be studied, and rare earth-based light emitters which are capable of emitting an optical code exclusive for that bead or particle. The device for reading the optical code includes a first excitation source for exciting the rare earth-based light emitters of each of the beads or particles, thereby causing the emitters to emit light, the emitted light having a unique ratio of at least two relative intensities, the unique ratio of the relative intensities forming the optical code of the bead or particle. The device further includes a color light detector for detecting the emitted light having the unique ratio of the relative intensities and a memory for storing an image of the emitted light having the unique ratio of the relative intensities.

In another embodiment, the system further comprises a computer for analyzing the image of the emitted light having the unique ratio of the relative intensities for each bead or particle and decoding the optical code from the image.

In another embodiment the reading device further comprises a second excitation source for exciting at least one reporter dye associated with the corresponding biomolecule attached to each of the beads or particles, thereby causing the at least one reporter dye to emit additional light, the detector also for detecting the additional light and the memory also for storing an image of the additional light, and the computer of the system also analyzes the additional light for each bead or particle's corresponding biomolecule.

In yet another embodiment, the system further comprises a bead or particle holder for holding the beads or particles and optically isolating the beads or particles from one another when read by the reading device. In some embodiments, the bead or particle holder comprises a substrate including a plurality of wells, each well for holding one of the beads or particles of the set.

In a further embodiment, the set of beads or particles contain more than 400 beads or particles.

### BRIEF DESCRIPTION OF THE DRAWINGS

FIG. 1 is a schematic illustration of an embodiment of bead reading device.

FIG. 2A is a plan view of an embodiment of a bead holder.

FIG. 2B is a plan view of one of the well defining regions of the bead holder substrate.

FIG. 2C is a sectional side view of one of the wells of the bead holder.

FIG. 3 is a schematic illustration of an embodiment of a color charge coupled device.

FIG. 4 is a plot of showing the spectral relationship between the color transmission filters of the CCD pixels and the emission wavelength of the RGB emitting encoding materials.

FIG. 5 is a plot comparing the visible reflectivity spectra of typical organic pigments observed with a halogen bulb excitation source.

FIG. 6A shows a JPEG format image for a SET-impregnated CPG bead sample with an IR filter.

FIG. 6B shows a transmission plot of an IR shortpass filter.

FIG. 6C is a JPEG format image for a SET-impregnated CPG bead sample without an IR filter.

FIG. 7A is a JPEG format image of pure Cy3 emission in CPG.

FIG. 7B is a plot showing the linear dependence of the red/green RAW data to the Cy3/Cy5 ratio.

FIG. 7C is a JPEG format image of pure Cy5 emission in CPG.

FIGS. 7D and 7E are plots showing the fluorescent intensity of the beads after washing versus the concentration of the Cy3-labeled 70-mer oligonucleotide solutions to which they were exposed.

FIG. 7F is a plot of the fluorescent intensity of the beads after washing versus the concentration of a 1:1 Cy3/Cy5 solution of labeled 70-mers.

FIG. 8A is a plot of the relative intensity ratio of two emitters versus their respective concentrations.

FIG. 8B is a JPEG image of a SET code in CPG.

FIG. 9A is a schematic illustration of a prior art point detection system.

FIG. 9B is a schematic illustration of a prior art area detection system.

FIG. 9C is a schematic illustration of a prior art hyperspectral imaging system.

FIG. 9D is a chart that qualitatively summarizes the prior art systems of FIGS. 9A-9C used for optically and spatially studying emissive beads.

### DETAILED DESCRIPTION OF THE INVENTION

Disclosed herein is a multiplex assay reader system (MARS) for reading bead-like structures (beads) and particles with optical codes. The MARS may be used for studying a wide variety of high throughput genomic and proteomic applications. The MARS is capable of resolving more than 400 multiplexed optical codes (optical codes which are mixed together and must be separately identified) provided by the beads and particles or approximately four times (4×) the maximum number of optical codes resolvable by other commercial bead-based reading systems. The MARS is also capable of reading reporter dye emission ratios and absolute values after hybridization with less than a 5% coefficient of variance.

In one embodiment, the MARS comprises a bead/particle-reading (BR) device and at least one set of optically encoded beads or particles (beads hereinafter) having surface functionalizations selected for attaching the desired biomolecules to be studied. In another embodiment, the MARS additionally comprises a computer running image analysis software that analyzes image data obtained by the BR device including relative emission intensity data produced by the beads and emission data produced by reporters associated with the correspondingly attached biomolecules, to decipher the optical codes of the beads and reporter ratios of the corresponding biomolecules. In still another embodiment, the MARS additionally comprises a bead holder for securely holding the beads during operation of the BR device and optically isolating the beads from one another. In yet another embodiment, the MARS additionally comprises a microtiter plate for holding the beads during operation of the BR device.

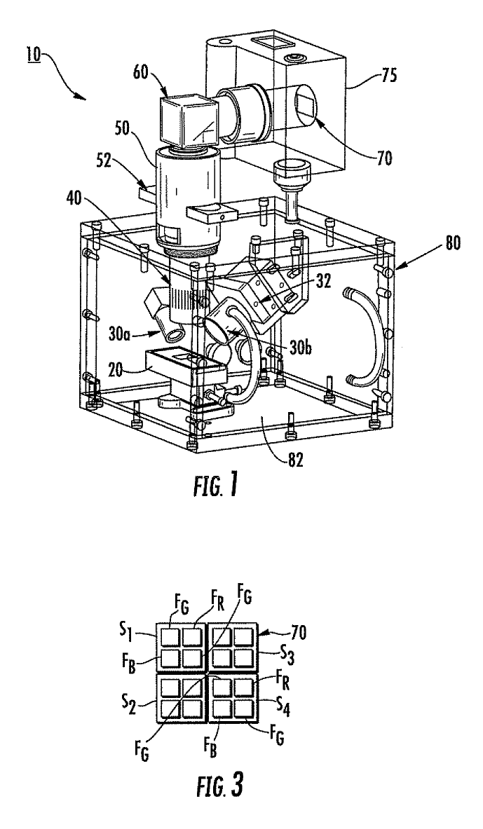

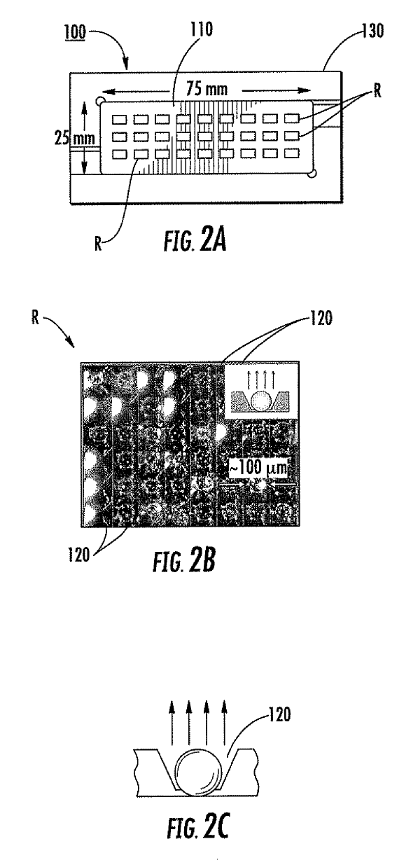

FIG. 1 is a schematic illustration of an embodiment of the BR device denoted generally by reference character 10. The BR device 10 comprises a stage 20 for mounting the bead holder 100 (FIG. 2A) or the microliter plate (not shown), excitation sources 30a and 30b for producing radiation of a wavelength that excites light emitters associated with the optically encoded beads and attached biomolecules, a color charge coupled device (CCD) 70 operative as a color detector for detecting light emitted by the light emitters of each bead, a microscope-type objective lens assembly 40 disposed above the stage 20 for focusing the light emitted by the light emitters, on the CCD 70, a filter unit 50 for removing excitation source radiation from the light emitted by the light emitters, disposed at an output of the objective lens 40, a mirror unit 60 disposed at an output of the filter unit 50 for turning the emitted light received from the filter unit 50 toward the CCD 70 and attaching the CCD 70 at an output thereof, and a non-transparent enclosure 80 enclosing the stage 20, the excitation sources 30a and 30b, and the objective lens 40.

The stage 20, in a preferred embodiment, is constructed and adapted for X-Y translation of the bead holder or microliter plate. In another preferred embodiment, the stage 20 is constructed and adapted for X-Y-Z translation of the bead holder or microliter plate.

The excitation sources 30a and 30b may comprise, without limitation, light-emitting-diodes (LEDs), small solid state lasers and laser diodes. In one embodiment, the excitation source 30a may comprise a 320 nm UV LED and the excitation source 30b may comprise a white LED with a filter assembly 32 including, for example but not limitation, red and green light filters, for extracting a desired color from the white light to excite the reporters (e.g., Cy3; excitation filter 531/40; Cy5: excitation filter 628/40). The small solid state lasers and laser diodes are desirable in applications where LEDs are not bright enough to cause detectable light emission from the light emitters associated with the beads and/or the reporters attached to biomolecules.

The color CCD 70 may be provided, in one embodiment, by a digital single-lens reflex (SLR) camera body 75 that includes a color CCD. Digital SLR camera bodies are relatively inexpensive and readily available from many different suppliers including, without limitation, NIKON, CANON, and OLYMPUS, to name a few. The use of a digital SLR camera body as the color CCD 70 in the BR device 10 allows for a very inexpensive MARS that is capable of resolving a larger number of optical codes than any prior art commercially available instrument or system. Moreover, the use of a digital SLR camera body avoids the need to provide a separate memory for storing RAW image files of the light emitted by the emitters of each bead and the reporter(s) of each bead's associated biomolecule, because the digital SLR camera body already includes a memory for storing the RAW images detected by the color CCD. Embodiments that do not employ a digital SLR camera body should include a separately provided color CCD and a separately provided memory for storing the RAW images detected by the color CCD. In embodiments that employ the digital SLR camera, the output of the mirror unit 60 of BR device 10 is constructed and adapted to attach to the standard lens mount of the digital SLR camera body. The RAW image files, i.e., the digital pictures of the light emitted by the emitters of each bead and the reporter(s) of each bead's associated biomolecule, may be obtained from the memory of the BR device 10 at the desired excitation wavelength, for image analysis.

In one embodiment, the color CCD 70 has pixels filtered by a red, green, blue (RGB) filters. Such color CCDs are typically used in digital SLR cameras. FIG. 3 shows an embodiment of the color CCD 70 with the RGB filters. As can be seen, each set S₁, S₂, S₃, S₄ of four CCD pixels has one pixel filtered by a red filter F_{R}, one pixel filtered by a blue filter F_{B}, and two pixels each filtered by a green filter F_{G}.

The microscope-type objective lens assembly 40 may comprise, but is not limited to a visible light microscope objective assembly or a UV light microscope objective lens assembly. The objective lens assembly 40 magnifies the light emitted from the emitters and reporters. In one embodiment where the beads are between about 5 microns and about 100 microns in diameter, the objective lens assembly 40 may have a magnification power of between about 2× and 20×.

The filter unit 50 may comprise a tube lens 51 for focusing the magnified light received from the objective lens assembly 40 onto the image plane of the color CCD detector. The filter unit may also include a filter assembly 52 comprising one or more bandpass filters, highpass filters, lowpass filters, and any combination thereof, to remove radiation generated by the excitation source(s), from the light emitted by the light emitters (e.g., Cy3: emission filter 593/40; Cy5: emission filter 692/40). The filter assembly 52 is, typically, positioned at the output of the tube lens 51.

The enclosure 80 is preferably constructed and adapted to prevent the entry of adscititious light into the interior of the enclosure 80. The enclosure includes a door-like closure 82 for gaining access to the bead holder, microliter plate, objective lens, and excitation source(s) for quick and easy removal and installation thereof.

In some embodiments, the BR device 10 is constructed and adapted to be completely modular such that any one or more of the components of the BR device 10 can be easily mounted and removed from the device 10, thereby allowing fast and easy changing of the components, if desired. The dimensions of the MARS depend upon the size of the beads, the focal lengths of the objective lens assembly 40 and field of view of the holder/microtiter

The BR device 10 is typically constructed and adapted to be AJC powered (e.g., the excitation sources, etc). In preferred embodiments, the BR device 10 is also constructed and adapted to be battery powered, if desired, to allow mobile and/or portable use of the device 10. In such an embodiment, the BR device 10 may use rechargeable or non-rechargeable batteries.

In one embodiment, the set of optically encoded beads comprises more than 400 different optically encoded beads, wherein each optical code is generated by narrow-band rare earth-based RGB emitters provided with each bead of the bead set. In one embodiment, the beads comprise porous glass beads, i.e., controlled pore glass beads (CPG), which have been impregnated with RGB rare earth-doped Yttrium Vanadate (YVO₄) emitters. In one preferred embodiment, the rare-earth RGB emitters comprise a Samarium (Sm) emitter for emitting red light, an Erbium (Er) emitter for emitting green light, and a Thulium (Tm) emitter for emitting blue light. The Sm, Er and Tm (SET) emitters may be provided in a YVO₄ host lattice. The SET emitters in the Y_{1-(x+y+z)}SmₓEr_{y}Tm_{z}VO₄ solid solution may be excited to produce narrow red, green, and blue light emission peaks that are nearly perfectly centered within the corresponding bandpasses or filter windows of the three RGB color filters that cover the pixels in the color CCD. The SET emitters in the Y_{1-(x+y+z)}SmₓEr_{y}Tm_{z}VO₄ solid solution may be excited using a version of the excitation source 30a of the BR device 10 that produces radiation or light at a wavelength of about 320 nm.

The optical code provided by the RGB emitters of each bead is based on the unique relative intensity ratio of the RGB light emitted by the excited emitters (i.e., the ratio of the intensity of one color to the intensity of the other color, or relative integrated fluorescence intensity or brightness) passing through the three RGB filters of the CCD. More specifically, because the SET emitters emit only into the red, green and blue filter windows, respectively, the optical code, i.e., the two emission ratios derived from the three SET emitters, can be very accurately determined by simply measuring the relative amount of light passing through the three RGB filters. Optical encoding using relative intensity ratios of RGB light is described in detail in U.S. patent application No. 10/890,530 entitled METHODS FOR OPTICALLY ENCODING AN OBJECT WITH UPCONVERTING MATERIALS AND COMPOSITIONS USED THEREIN; International Application Publication No. WO 2006/047621, entitled RARE EARTH DOWNCONVERTING PHOSPHOR COMPOSITIONS FOR OPTICALLY ENCODING OBJECTS AND METHODS AND APPARATUS RELATING TO SAME; and International Application Publication No. WO 2007/051035, entitled METHODS FOR FABRICATING OPTICALLY ENCODED PARTICLES AND METHODS FOR OPTICALLY ENCODING OBJECTS WITH SUCH PARTICLES, the entire disclosures of which are incorporated herein by reference.

Each optically encoded bead is synthesized to include at least one functional group selected for attaching at least one desired biomolecule to the bead. The functional groups may include, without limitation, epoxide, aldehyde and amine groups or any combination thereof. The functional groups enable a wide variety of biomolecules to be attached.

After the optical code has been obtained from each of the beads, colored reporter dye or dyes attached to the corresponding biomolecule of interest may be excited with extremely high selectivity over the inorganic optical code (e.g., the optical code emitted by the rare earth doped YVO₄ emitters) due to the insignificant overlap in the excitation spectra of the colorless rare earth doped YVO₄ emitters and the colored reporter dyes, thereby allowing assessment of the reaction under consideration. In one embodiment, the colored reporter dyes may comprise, without limitation, fluorescent dyes of the cyanine dye family, such as Cy3 9 (red) and Cy5 (far-red). Such dyes are used in a wide variety of biological applications including genomic and proteomic experimentation and investigation. The Cy3 and Cy5 dyes may be excited using a version of the excitation source 30b of the BR device 10 that emits a white light (appropriately filtered for the desired dye).

FIGS. 2A-2C collectively show an embodiment of the bead holder denoted generally by reference character 100. The bead holder 100 comprises a substrate 110 having a plurality of wells 120, and fiduciary or indicator marks (not shown) for indexing the substrate 110. In one embodiment, each of the wells 120 includes one or more apertures at the bottom thereof (not shown) for draining or filtering a washing medium from the well 120, thereby enabling the beads to be washed while located in the wells 120 of the bead holder 100. The substrate 110 may be formed from silicon, glass, ceramic, and other micromachinable materials. The wells 120, apertures and marks may be micromachined into the substrate using well known micromachining techniques. The substrate 110 may be disposed in a conventional vacuum filtration fixture 130, which creates a vacuum at the bottom of each well 120, via the one or more apertures at the bottom thereof. The vacuum is useful for retaining the beads in the wells 120 and draining or filtering the washing medium from the wells 120. In other embodiments, a non-fluorescent adhesive (e.g., polymer adhesive) may be used to retain the beads in the wells 120, instead of the vacuum filtration fixture 130. The wells 120 of the bead holder substrate 110 each have a depth, which is approximately equal to the diameter of the bead. In one embodiment, the substrate 110 of the bead holder 100 may be the size of a typical microscope slide with dimensions of 25 mm×75 mm. The substrate 110 may have 27 regions R, each of which defines 384 wells 120. Each region R of wells 120 is capable of holding and filtering 384 100 μ diameter beads or 10,368 beads total. Upon excitation from the top (upright microscope embodiments as shown in FIG. 1, where the objective is located above the bead holder 100) or bottom side (inverted microscope embodiments of the BR device 10 where the objective lens assembly is located below the bead holder 100) of the bead holder 100, the emission from each bead (FIG. 2C) is directed upward (optically collimated), perpendicular to the plane of the substrate 110 and no emission impinges on any beads from proximate neighboring beads. Accordingly, the wells 120 of the bead holder substrate 110 are capable of optically isolating the beads from one another.

The computer running the image analysis software should be capable of performing the appropriate numerical computations and analysis required to decode the RAW images of the emitter emissions. Suitable commercially available numerical computation and analysis software for decoding the RAW images of the emitter emissions includes, without limitation, MATLAB available from MATHWORKS and LABVIEW available from NATIONAL INSTRUMENT. The image analysis software analyzes the image data obtained by the BR device 10 including the relative emission intensity data produced by the beads and the emission data produced by reporters of the correspond biomolecules, to decipher or decode the optical codes of the beads and reporter ratios of the biomolecules. More specifically, the software integrates and averages the emission from groups of beads. The software recognizes the bead's outline and calculates an intensity value for each pixel on each particle or bead. When two particles or beads are determined to have the same optical code (i.e. a replicate sample), the software averages the data from multiple beads. It is possible to obtain % CV (coefficient of variance) values around 5-8% when averaging integrated intensity between two groups of greater than 10-20 beads.

By placing the fiduciary marks on the bead holder substrate 110, and knowing the well-to-well spacing, the image analysis software is capable of recognizing the location of the beads and assigning the appropriate optical code to the appropriate image location. In one embodiment, the software from the digital SLR camera is used to control all of the camera functions and to export the data to software for analysis.

In one embodiment, the MARS may be used to perform a hybridization experiment where sample and control DNA targets are competing for a common surface-bound probe. In such an experiment, 400 different probe DNA sequences (biological molecules) may be attached to 400 of the above-described beads and the beads incubated with the labeled target mixture (which includes the reporter dyes). The beads may then be placed into the bead holder to prevent optical cross talk. The emitters of the beads may be excited and then read, as described above using the BR device 10. RAW image files of the bead emissions may be obtained from the CCD 70 of the BR device 10 for image analysis by the computer running the image analysis software, to determine the optical codes of the beads and reporter ratios of the probe DNA sequences.

As should now be apparent, the MARS enables virtually any genomic laboratory to simultaneously perform multiplexed analyses on greater than 400 samples without the use of microarrays, scanners, microcontact printers, core facilities or hybridization cassettes.

### Discussion of Test Results

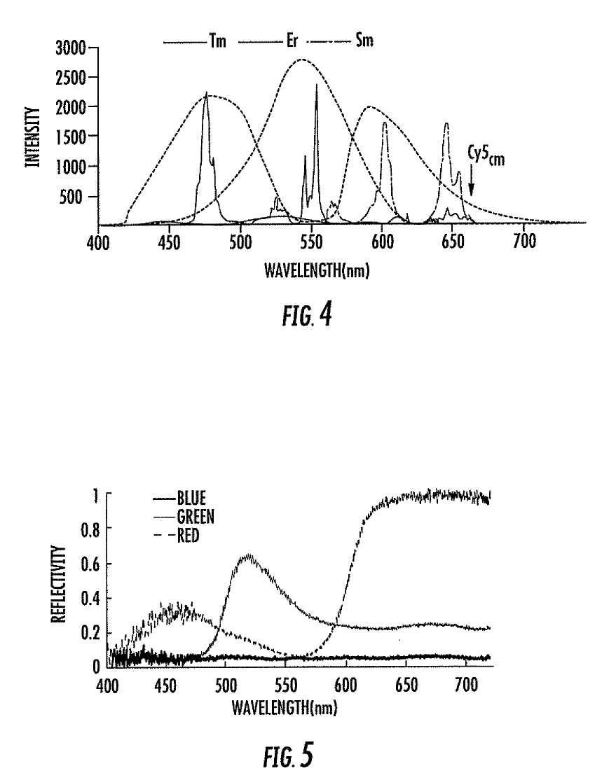

It is important to emphasize that it is the combination of the SET emitters emitting at the proper wavelengths, and their peak width relative to the width of the color CCD filter transmission windows, which allows the color CCD to function as a color detector. As shown in the plot of FIG. 4, which shows the spectral relationship between the color transmission filters of the CCD pixels (FIG. 3 shows the arrangement of the

RUB filters relative to the pixels of the CCD) and the emission wavelength of the RGB-emitting SET encoding materials, the rare earth-based SET emitters have very narrow peak widths compared to the width of color transmission windows provided by organic materials forming the color filter of the color CCD, which effectively eliminates any optical cross talk among the filter channels for the emitters. Since the peak RGB emission wavelengths are well centered in the RGB filter windows, and their narrow peak width precludes all but small and correctable leakage from one emitter into the adjacent color filter channels, it possible to very accurately integrate the relative fluorescent intensity of the emitters. These data also clearly illustrate the substantial difference in peak widths of ƒ-block elements (SET emitters) and organic materials (the CCD filter materials). As will be discussed below, the relative intensities of the SET emitters may be resolved in 5% compositional increments or better.

On the other hand, FIG. 5 is a plot comparing the visible reflectivity spectra of typical organic pigments, i.e., laser toner from a color laser printer, observed with a halogen bulb excitation source. The spectra clearly show the broad peaks and the substantial overlap typically associated with RGB organic dyes and pigments that lead to decreased confidence when integrating the relative intensities of the organic RGB species (i.e. the putative optical code) as compared to the narrow band emitters in the SET materials. The substantial overlap of the organic RGB components precludes their use to resolve fine relative increments of color mixtures.

It is also very important to note that there is absolutely no requirement for any type of external color calibration when using the SET emitters for optical encoding because the decoding is always performed pair wise with two emitters in a ratiometric manner. This method essentially uses one of the three colors as an internal standard to create the encoded intensity ratios. The method substantially differs from methods using organic dyes (i.e. in color printing) where color comparisons are made and adjusted employing very expensive color scanners and software/hardware calibration procedures.

It was observed that green Er to red Sm and Cy3 to Cy5 ratios measured with the color CCD (of a NIKON D-50 digital SLR camera) differed from those measured by the several other spectrometers and detector systems. In addition, an early experiment performed to measure the Cy3 to Cy5 emissions (with emission maximas 563 nm and 662 nm, respectively) in 1:1 standard mixtures indicated that the 662 nm Cy5 emission was greatly suppressed. Inspection of the transmission as a function of wavelength through the red filter on the CCD, as shown in FIG. 4, indicates that most of the light greater than 650 nm is removed by the red filter. This avoids saturating the silicon CCD with light in the region where it is most sensitive and which is virtually invisible to the human eye.

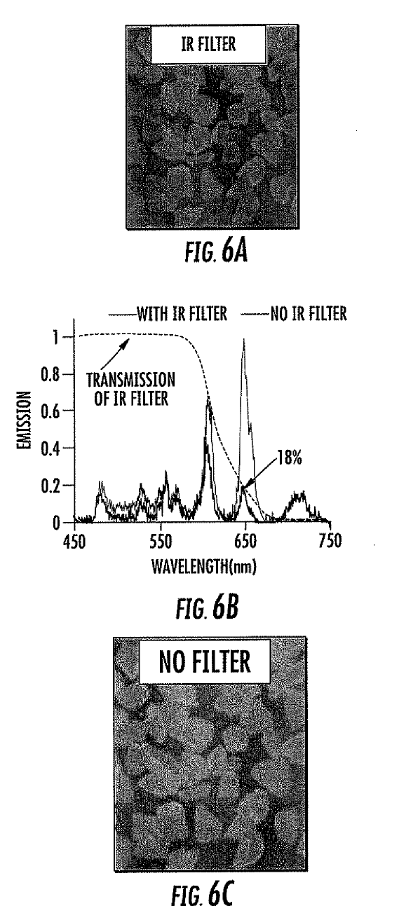

Further examination of the NIKON color CCD indicated that in addition to the broad bandpass nature of the red filter shown in FIG. 4, all of the pixels are covered with an IR shortpass filter that blocks essentially all of the light above about 680 nm. Removal of this filter allows the measurement of accurate ratios throughout the desired visible and near IR wavelengths ranges as shown in FIGS. 6A-6C. More specifically, the dashed line in FIG. 6B shows the transmission plot of the IR shortpass filter, which avoids saturating the CCD in the region of its greatest sensitivity. The preferential attenuation of the more red regions of the SET optical code is shown in the RAW response plot of FIG, 6B and in the REG format images of FIGS. 6A and 6C for SET-impregnated CPG bead samples.

FIG. 6A shows the JPEG format image for a SET-impregnated CPG bead sample with the IR filter and FIG. 6C shows the JPEG format image for a SET-impregnated CPG bead sample without the IR filter. This data was obtained with a 320 nm LED excitation source.

The data shown discussed below indicates that the MARS can measure both the SET codes and Cy3/Cy5 ratios at 5% relative compositional ratios thereby exceeding the multiplexing depth for any current optically encoded bead set by approximately 4 times, while providing two color ratiometric dye reporter data of an accuracy suitable for virtually any type of experiment.

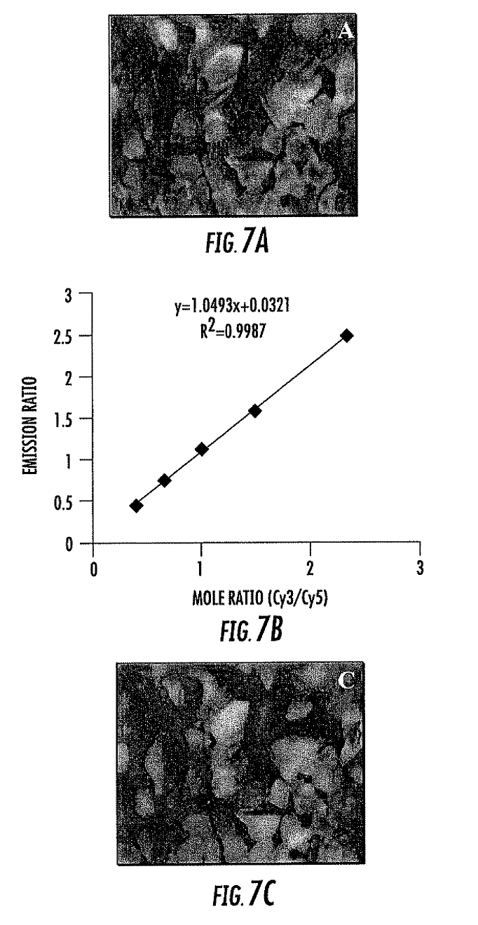

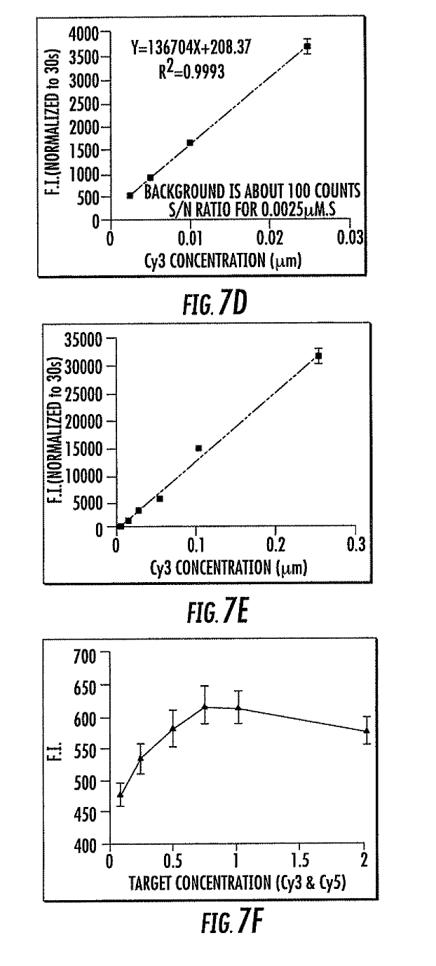

Experiments were performed to determine if the CCD of a digital SLR camera, such as a NIKON D-50 digital SLR camera, would display linear behavior with respect to relative amounts of two colors of variable brightness. When concerned only with response linearity the Nikon CCD was statistically indistinguishable in performance from a cooled single photon Andor Electron Multiplying CCD (EMCCD). To estimate the resolvable resolution of Cy3/Cy5 dyes, solution samples at 10% compositional intervals were prepared and the samples measured with the NIKON CCD. Solutions (1 μM) of Cy3 and Cy5, corresponding to the ratios 30:70, 40:60, 50:50, 60:40 and 70:30, were absorbed into CPG and imaged (RAW format) with the NIKON CCD. Analysis of the RAW images of the solutions with a computer running MATLAB image analysis software shows in FIG. 7B that there is a linear dependence of the red/green RAW data to the Cy3/Cy5 ratio. JPEG format images of the pure Cy3 and Cy5 emission in CPG are shown FIG. 7A and FIG. 7C, respectively. The plots of FIG. 7D and FIG. 7E show that the amount of labeled DNA on the beads after washing is linearly proportional, over at least two orders of magnitude, to the concentration of the Cy3-labeled 70-mer oligonucleotide solutions to which they were exposed. Furthermore, the sensitivity of the system is such that a 0.0025 μM solution absorbed can be detected on the beads with a S/N ratio of approximately 5, as shown in the plot of FIG. 7D. The actual probe DNA concentration to be used in experiments, i.e. the amount required to saturate about 30% of the surface, is determined from the saturation plot shown in FIG. 7F, where the concentration of a 1:1 Cy3/Cy5 solution of labeled 70-mers is plotted against the fluorescent intensity of the beads after washing. The saturation value of approximately 30% near 0.2 μM shown in the plot of FIG. 7F is nearly 100 times greater than the detection limit as revealed in the plot of FIG. 7D.

The strictly linear behavior of the emission ratio versus 10% compositional ratios (FIG. 713), with R² of 0.999, suggests that 5% or finer compositional intervals should be resolvable. For two component (color) systems resolvable A/B ratios of 5% means that 20 different Cy3/Cy5 ratios could be distinguished which provides sufficient accuracy for almost all experiments. As shown in FIGS. 7D, 7E and 7F, the imaging system can detect beads treated with a 0.0025 μM solution with S/N of approximately 5.

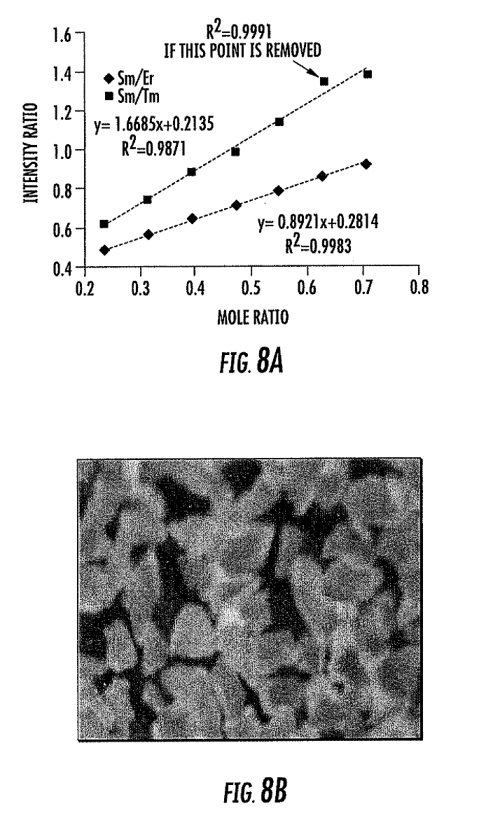

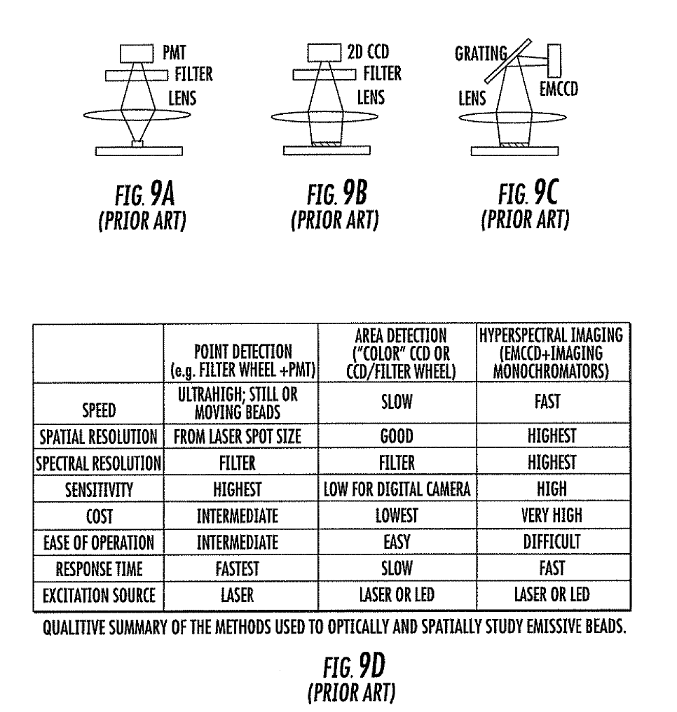

Experiments similar to the ratiometric Cy3/Cy5 studies were performed with various ratios within the SET compositional space to determine the resolution at which the ratios of emitters can be measured. The plot of FIG. 8A demonstrates that a resolution of greater than 400 optical codes can be obtained with a three-color RGB SET encoding system using the NIKON D-50 CCD detector. Seven samples of CPG impregnated with Y_{0.9905} (SmₓEr_{0.005}Tm_{0.0045})VO₄, where x=0.0012, 0.0016, 0.002, 0.0024, 0.0028, 0.0032 and 0.0036, show a linear dependence of the ratio of the two emitters with respect to the ratio of their respective concentrations. As can be seen, there is a linear dependence of the ratio of Sm/Er and Sm/Tm on their relative concentrations. Since earlier experiments showed R² values approaching unity for 10% compositional intervals it seems realistic to assume 5% intervals could be resolved in an optimized system. For a three color system where A/B and A/C are resolvable in 5% increments there are 400 optical codes available. The deepest multiplexing level offered in commercial systems is around 100 codes. FIG. 8B shows a JPEG image of one of the SET codes in a CPG bead.

One reason the MARS is able to resolve the large number optical codes is the larger bit depth of the CCD when operated in the RAW mode (12 bits) as compared to the familiar JPEG (8 bits). The RAW output is simply the time sum of the current from each RGB pixel accumulated during exposure and the full 12 bits of the detector available for measurement of the signal and noise (noise is about 2 bits). For the results discussed herein, the relative ratiometric optical data were acquired in the RAW format while the images were all JPEG.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A system for reading optical codes, the system comprising:
a set of beads or particles, each of the beads or particles having a surface functionalization selected for attaching a biomolecule to be studied, each of the beads or particles including rare earth-based light emitters which are capable of emitting an optical code exclusive for that bead or particle; and
a device for reading the optical code of each of the beads or particles, the device including:
a first excitation source for exciting the rare earth-based light emitters of each of the beads or particles, thereby causing the emitters to emit light, the emitted light having a unique ratio of at least two relative intensities, the unique ratio of the relative intensities forming the optical code of the bead or particle;
a color light detector for detecting the emitted light having the unique ratio of the relative intensities; and
a memory for storing an image of the emitted light having the unique ratio of the relative intensities.

2. The system according to claim 1, further comprising a computer for analyzing the image of the emitted light having the unique ratio of the relative intensities for each bead or particle and decoding the optical code from the image.

3. The system according to claim 1, wherein the reading device further comprises a second excitation source for exciting at least one reporter dye associated with the corresponding biomolecule attached to each of the beads or particles, thereby causing the at least one reporter dye to emit additional light, the detector also for detecting the additional light and the memory also for storing an image of the additional light.

4. The system according to claim 3, further comprising a computer for analyzing the image of the light for each bead or particle and the additional light for each bead or particle's corresponding biomolecule and decoding the optical code and reporter dye emission intensity from the images.

5. The system according to claim 1, further comprising a bead or particle holder for holding the beads or particles and optically isolating the beads or particles from one another when read by the reading device.

6. The system according to claim 5, wherein the bead or particle holder comprises a substrate including a plurality of wells, each well for holding one of the beads or particles of the set.

7. The system according to claim 1, wherein the set of beads or particles contain more than 400 beads or particles.

8. The system according to claim 1, wherein the beads comprise porous glass beads which have been impregnated with the rare earth-based emitters.

9. The system according to claim 8, wherein the rare earth-based emitters include a first emitter for emitting red light, a second emitter for emitting green light, and a third emitter for emitting blue light.

10. The system according to claim 9, wherein the first emitter comprises Samarium, the second emitter comprises Erbium, and the third emitter comprises Thulium.

11. The system according to claim 10, wherein the Samarium, Erbium, and Thulium emitters are disposed in a Yttrium Vanadate host lattice.

12. The system according to claim 1, wherein the rare earth-based emitters include a first emitter for emitting red light, a second emitter for emitting green light, and a third emitter for emitting blue light.

13. The system according to claim 1, wherein the rare earth-based emitters comprise Samarium, Erbium, and Thulium.

14. The system according to claim 13, wherein the Samarium, Erbium, and Thulium emitters are disposed in a Yttrium Vanadate host lattice.

15. The system according to claim 1, wherein the color light detector comprises a charge coupled device.

16. The system according to claim 1, wherein the color light detector comprises a digital single-lens reflex camera.

17. The system according to claim 1, wherein the first excitation source comprises an LED or a laser.

18. The system according to claim 3, wherein the first excitation source comprises an LED or a laser and the second excitation source comprises an LED or a laser.

19. A device for reading optical codes provided by a set of beads or particles, each of the beads or particles having a surface functionalization selected for attaching a biornolecule to be studied, each of the beads or particles including rare earth-based light emitters which are capable of emitting an optical code exclusive for that bead or particle, the device comprising:
a first excitation source for exciting the rare earth-based light emitters of each of the beads or particles, thereby causing the emitters to emit light, the emitted light having a unique ratio of at least two relative intensities, the unique ratio of the relative intensities forming the optical code of the bead or particle;
a color light detector for detecting the emitted light having the unique ratio of the relative intensities; and
a memory for storing an image of the emitted light having the unique ratio of the relative intensities.

20. The device according to claim 19, further comprising a second excitation source for exciting at least one reporter dye associated with the corresponding biomolecule attached to each of the beads or particles, thereby causing the at least one reporter dye to emit additional light, the detector also for detecting the additional light and the memory also for storing an image of the additional light.

21. A method for reading optical codes, the method comprising the steps of:
providing a set of beads or particles, each of the beads or particles having a surface functionalization selected for attaching a biomolecule to be studied, each of the beads or particles including rare earth-based light emitters which are capable of emitting an optical code exclusive for that bead or particle;
exciting the rare earth-based light emitters of each of the beads or particles with an LED or laser, thereby causing the emitters to emit light, the emitted light having a unique ratio of at least two relative intensities, the unique ratio of the relative intensities forming the optical code of the bead or particle;
detecting the emitted light having the unique ratio of the relative intensities with a charge-coupled-device of a digital single-lens reflex camera body; and
storing an image of the emitted light having the unique ratio of the relative intensities.
